(19) United States
(12) Patent Application Publication
(10) Pub. No.: US 2003/0202014 A1
(43) Pub. Date: Oct. 30, 2003

(54) Graphical user interface development tool

(75) Inventor: Brian Owen Wood, Byron, MN (US)

Correspondence Address: IBM CORPORATION, ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY

(21) Appl. No.: 10/132,054

(22) Filed: Apr. 25, 2002

(51) Int. Cl. G09G 5/00

(52) U.S. Cl. 345/763; 345/762; 345/967

(57) ABSTRACT

Embodiments of the present invention generally are directed to a method of building a graphical user interface panel, which includes the step of: receiving a first set of user inputs selecting the panel and one or more components contained within the panel; using a set of information regarding the panel and components received from a run-time manager to generate an image of the panel and the components; and displaying the image of the panel and the components.

### BACKGROUND OF THE INVENTION

1. Field of the Invention

The present invention generally relates to a graphical user interface, and more specifically, a tool for developing a graphical user interface.

2. Description of the Related Art

Early computer systems used command-based operating systems and software applications. These command-based systems provided a user interface that required the user to memorize a relatively large number of commands in order to perform meaningful work. The user interfaces for these command-driven computer programs required a relatively high level of skill to operate, and were not considered to be “user-friendly.” With the introduction of the IBM personal computer (PC), computers became more widely available, both in the workplace and in homes, and the computer industry soon recognized the need to provide more user-friendly interfaces to computer programs. As a result, many different operating systems were introduced that provided a graphical user interface (GUI), including IBM's OS/2, Microsoft Windows, and the Apple Macintosh. Software applications with graphical user interfaces soon followed, and the vast majority of computer programs running on personal computers today provide a user-friendly graphical user interface.

Most graphical user interfaces provide many common features. The basic display area in a graphical user interface is known as a window or panel. A single panel may fill the entire display, or the display can be split into a number of different panels. A panel may include a number of different “components”, which are different areas that display text, drop-down lists, text entry fields, buttons, etc. A pointing device such as a trackball or a mouse is generally used to select various commands and options on a panel by clicking on the appropriate fields or buttons within the panel. In addition, a keyboard is commonly used to enter text information into a panel.

Various methods have been developed for generating panels. For example, a builder provided with Microsoft Visual C++ provides a graphical tool that allows a programmer to define a panel that may be displayed using Microsoft Windows by selecting and dropping desired components onto the panel. When the programmer is finished, the panel is defined as a Windows resource script (.rc file). Resource script is a special programming language that allows a user to define the appearance and function of a panel. Of course, when a programmer uses a graphical tool to generate a panel, the tool translates the components the programmer sees on the panel into a corresponding resource script without the programmer directly writing code in resource script format. An example of a panel defined in Windows resource script is shown in FIG. 1, with the corresponding resource script shown in FIGS. 2A and 2B.

While generating panels using Visual C++ is relatively straightforward, the resulting panels in resource script format can only be displayed on a Microsoft Windows platform. This is due to the fact that graphical user interface definitions are commonly created for only one specific platform at a time. Today, there is a substantive effort to provide software applications that are “platform-independent”, which means that a software application may run on computer systems that have different operating systems, such as OS/2, Windows, AIX, AS/400, etc. The panel, components and the general layout of a graphical user interface (GUI) typically vary from one platform to another. Thus, when a GUI developer desires to develop a GUI for more than one platform, the developer typically is required to use a different GUI builder/editor for each platform.

A need, therefore, exists for an improved method, apparatus and system for building a graphical user interface.

### SUMMARY OF THE INVENTION

Embodiments of the present invention generally are directed to a method of building a graphical user interface panel. In one aspect, the method comprises: receiving a first set of user inputs selecting the panel and one or more components contained within the panel; using a set of information regarding the panel and components received from a run-time manager to generate an image of the panel and the components; and displaying the image of the panel and the components.

In one embodiment, the present invention is directed to method of refreshing a graphical user interface panel having one or more components contained within the panel. The method comprises: receiving a user input selecting a run-time manager for a desired platform; transferring to the run-time manager a set of tag language associated with the panel and the control. The set of tag language is configured to define the panel and the components The method further comprises: requesting from the run-time manager a set of information regarding the panel and components; receiving from the run-time manager the set of information regarding the panel and the components; using the set of information regarding the panel and components to generate an image of the panel and the components; and displaying the image of the panel and the components.

In another embodiment, the present invention is directed to a computer readable medium containing a program which, when executed, performs an operation comprising: receiving a first set of user inputs selecting the panel and one or more components contained within the panel; using a set of information regarding the panel and components received from a run-time manager to generate an image of the panel and the components; and displaying the image of the panel and the components.

In still another embodiment, the present invention is directed to a computer readable medium containing a program which, when executed, performs an operation comprising: receiving a user input selecting a run-time manager for a desired platform; transferring to the run-time manager a set of tag language associated with the panel and the control, in which the set of tag language defines the panel and the components; requesting from the run-time manager a set of information regarding the panel and components; receiving from the run-time manager the set of information regarding the panel and the components; using the set of information regarding the panel and components to generate an image of the panel and the components; and displaying the image of the panel and the components.

In yet another embodiment, the present invention is directed to a computer, which includes a memory containing a graphical user interface-refreshing program; and a processor which, when executing the graphical user interface-refreshing program, performs an operation. The operation comprises: receiving a first set of user inputs selecting the panel and one or more components contained within the panel; using a set of information regarding the panel and components received from a run-time manager to generate an image of the panel and the components; and displaying the image of the panel and the components.

In still yet another embodiment, the present invention is directed to a computer, which includes a memory containing a graphical user interface-building program; and a processor which, when executing the graphical user interface-building program, performs an operation. The operation comprises: receiving a user input selecting a run-time manager for a desired platform; transferring to the run-time manager a set of tag language associated with the panel and the control, in which the set of tag language defines the panel and the components; requesting from the run-time manager a set of information regarding the panel and components; receiving from the run-time manager the set of information regarding the panel and the components; using the set of information regarding the panel and components to generate an image of the panel and the components; and displaying the image of the panel and the components.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a display of a user interface panel defined using an editor for generating a Windows panel, such as that provided by Microsoft Visual C++;

FIGS. 2A-2B show the Windows resource script for the panel of FIG. 1;

FIG. 3 is a block diagram of a computer system in accordance with an embodiment of the present invention;

FIG. 4 illustrates a process for building a GUI panel in accordance with an embodiment of the present invention;

FIG. 5A illustrates an image of a log-on GUI panel for Windows® in accordance with an embodiment of the invention;

FIG. 5B illustrates an image of a log-on GUI panel for HTML in accordance with an embodiment of the invention;

FIG. 6 illustrates a diagram of various run time managers interacting with the GUI builder in accordance with an embodiment of the invention; and

FIG. 7 is a block diagram of the interaction between the GUI builder and a run time manager is illustrated in accordance with an embodiment of the invention.

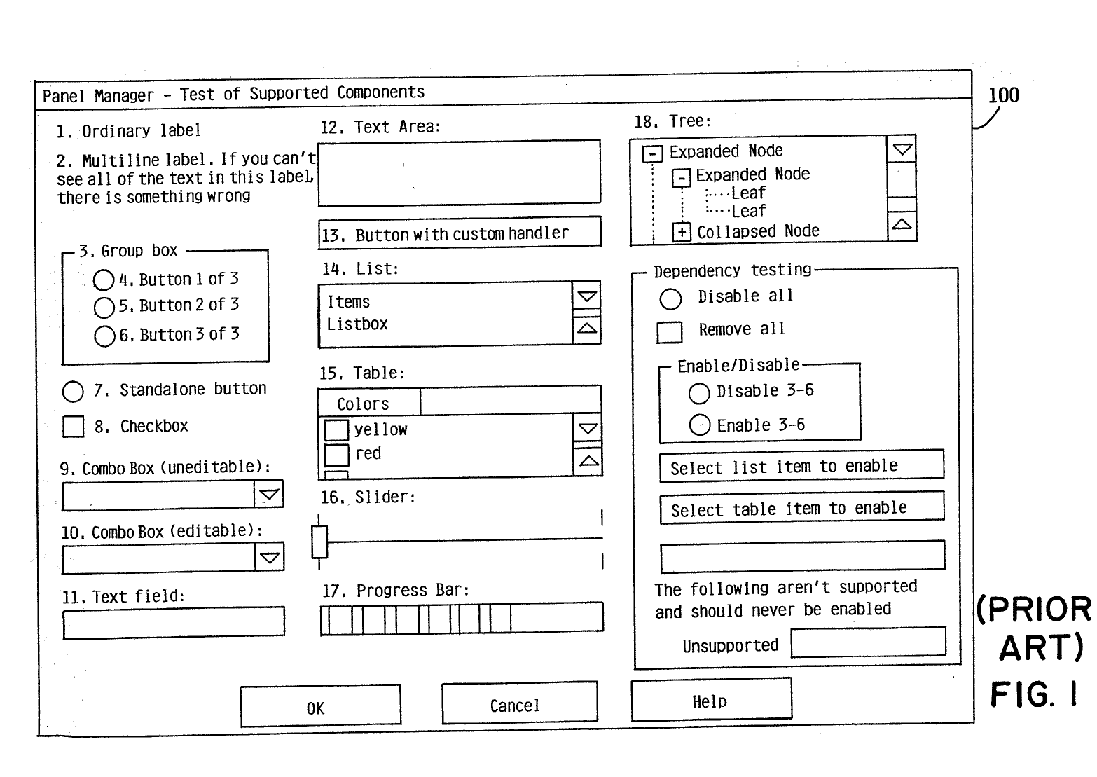

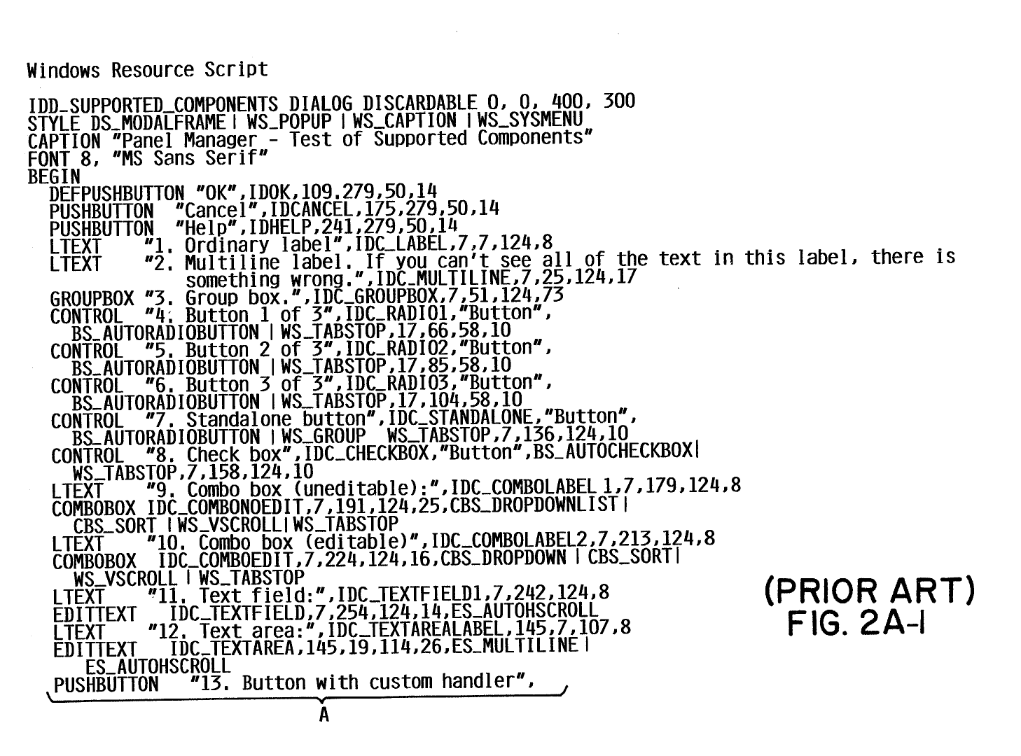

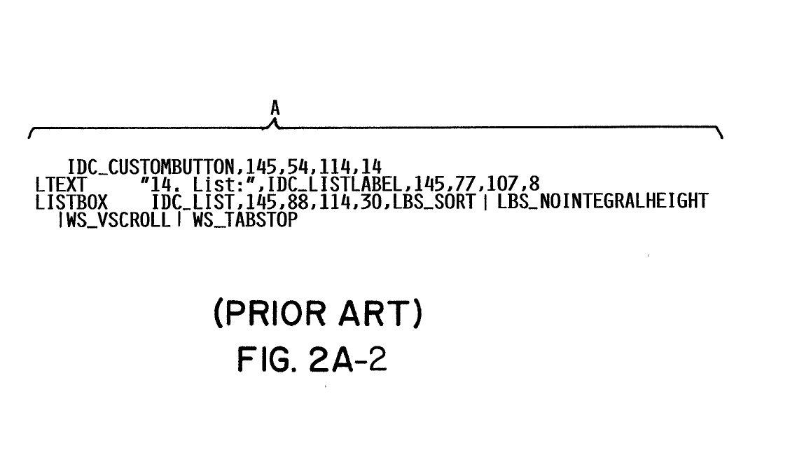

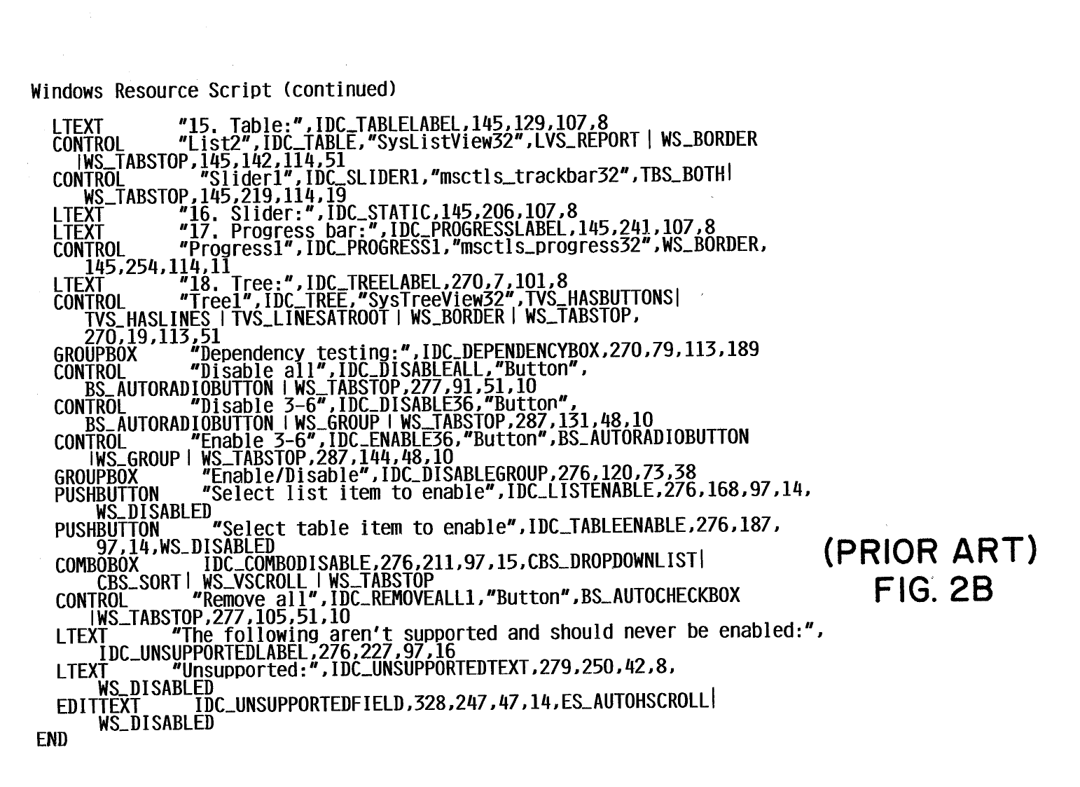

### DETAILED DESCRIPTION OF THE PREFERRED EMBODIMENTS

The present invention is generally directed to a graphical user interface (GUI) panel builder. In one aspect, the builder includes a computer program that generates an image of the panel and the components contained therein. In accordance with an embodiment of the present invention, the image of the panel and the components is a substantial representation of the actual implementation of the panel and the components. That is, the image is a what you see is what you get (“WYSIWYG”) representation of the actually implemented panel and its components. Thus, by using the embodiments of the present invention, the developer can see, in real time, exactly how the panel being built will look at run-time. In one embodiment, the GUI panel builder retrieves a set of information regarding the panel and the components from a run-time manager after the run-time manager generates the actual implementation of the panel and the components. Using the retrieved set of information, the GUI panel builder generates an image of the panel and the components.

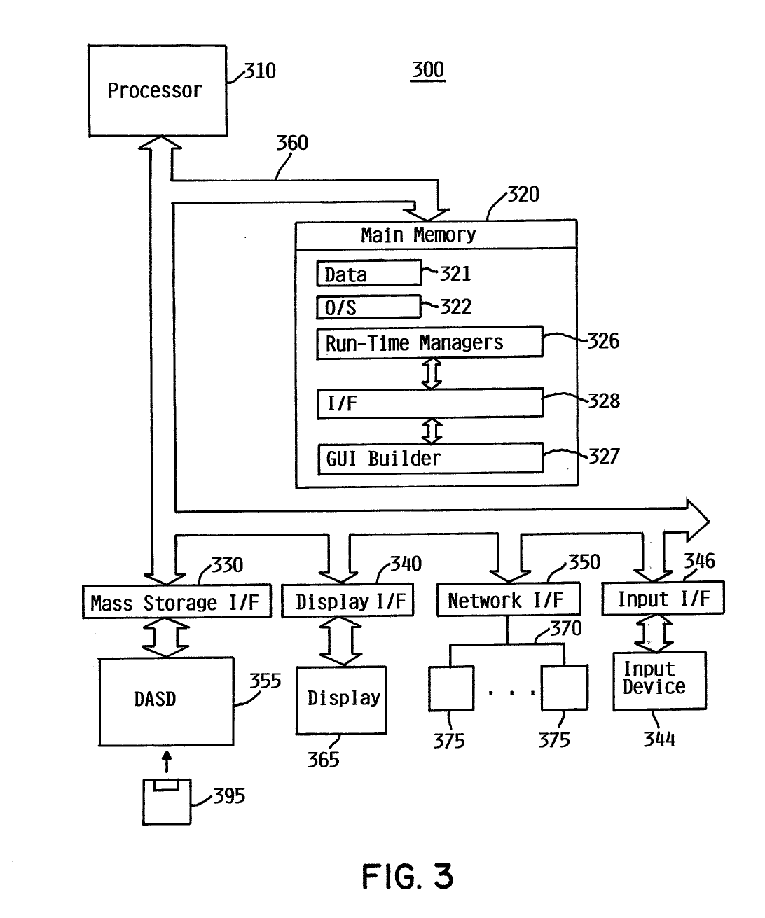

One embodiment of the invention is implemented as a program product for use with a computer system such as, for example, the computer system 300 shown in FIG. 3 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Referring now to FIG. 3, a computer system 300 in accordance with an embodiment of the present invention is shown. The computer system 300 may represent any type of computer, computer system or other programmable electronic device, including a client computer, a server computer, a portable computer, an embedded controller, a PC-based server, a minicomputer, a midrange computer, a mainframe computer, and other computers adapted to support the methods, apparatus, and article of manufacture of the invention. Illustratively, the computer system 300 is a standalone device; however, in other embodiments, the computer system 300 is part of a networked system. In this regard, the invention may be practiced in a distributed computing environment in which tasks are performed by remote processing devices that are linked through a communications network. In a distributed computing environment, program modules may be located in both local and remote memory storage devices.

In any case, it is understood that FIG. 3 is merely one configuration for a computer system. Embodiments of the invention can apply to any comparable configuration, regardless of whether the computer system 100 is a complicated multi-user apparatus, a single-user workstation, or a network appliance that does not have non-volatile storage of its own.

As shown in FIG. 3, the computer system 300 includes a processor 310 connected to a main memory 320, a mass storage interface 330, a display interface 340, and a network interface 350. These system components are interconnected through the use of a system bus 360. The mass storage interface 330 is used to connect mass storage devices (such as a direct access storage device 355) to the computer system 100. One specific type of direct access storage device is a floppy disk drive, which may store data to and read data from a floppy diskette 395. Another specific type of direct access storage device is an optical storage. Although storage 355 is shown as a single unit, it could be any combination of fixed and/or removable storage devices, such as fixed disc drives, floppy disc drives, tape drives, removable memory cards, or optical storage. The main memory 320 and the storage device 355 could be part of one virtual address space spanning multiple primary and secondary storage devices.

The computer system 300 also includes an input device 344 coupled to the system bus 360 via an input interface 346. The input device 344 can be any device to give input to the computer system 300. For example, a keyboard, keypad, light pen, touch screen, button, mouse, track ball, or speech recognition unit could be used. Further, although shown separately from the input device, the terminal 365 and input device 344 could be combined. For example, a display screen with an integrated touch screen, a display with an integrated keyboard or a speech recognition unit combined with a text speech converter could be used.

The contents of main memory 320 can be loaded from and stored to the storage device 355 as processor 310 has a need for it. Main memory 320 is any memory device sufficiently large to hold the necessary programming and data structures of the invention. The main memory 320 could be one or a combination of memory devices, including random access memory (RAM), non-volatile or backup memory such as programmable or flash memory or read-only memory (ROM). The main memory 320 may be physically located in another part of the computer system 300. While main memory 320 is shown as a single entity, it should be understood that memory 320 may in fact comprise a plurality of modules, and that main memory 320 may exist at multiple levels, from high speed registers and caches to lower speed but larger DRAM chips.

In one embodiment, the main memory 320 contains data 321, an operating system 322, one or more run-time managers 326, an improved graphical user interface (GUI) panel builder 327, and an interface 328 for facilitating communication between the run-time managers 326 and the GUI panel builder 327. The computer system 300 may utilize well known virtual addressing mechanisms that allow the programs of the computer system 300 to behave as if they only have access to a large, single storage entity instead of access to multiple, smaller storage entities such as the main memory 320 and DASD device 355. Therefore, while data 321, the operating system 322, the run-time managers 326, and the GUI panel builder 327 are shown to reside in the main memory 320, those skilled in the art will recognize that these items are not necessarily all completely contained in the main memory 320 at the same time. It should also be noted that the term “memory” is used herein to generically refer to the entire virtual memory of the computer system 300.

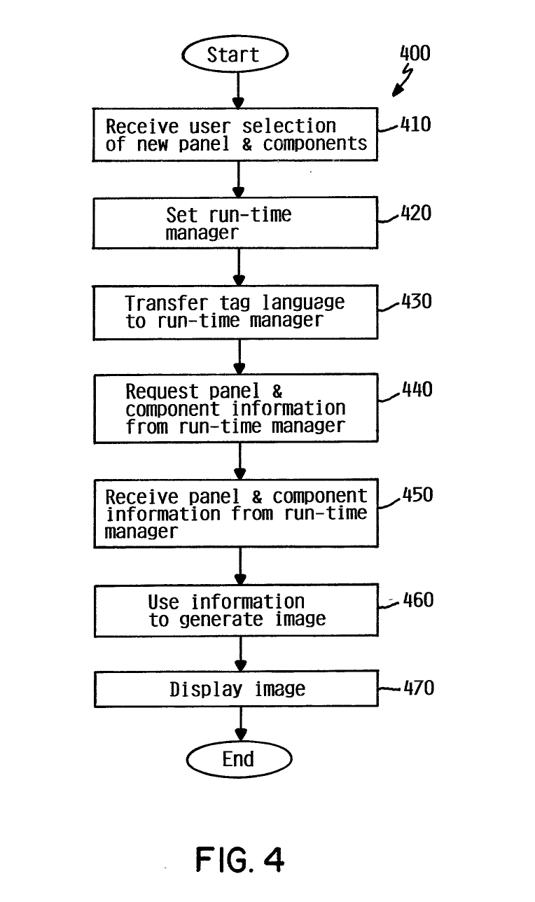

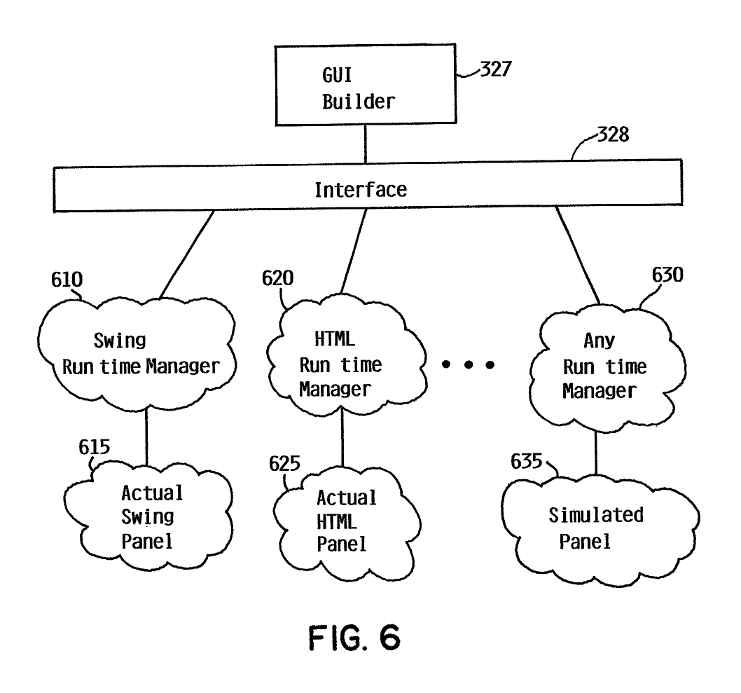

Run-time managers 326 (which may also be referred to as renderers or simulators) are generally configured to generate the actual implementation/appearance of the GUI panel in a specific target platform, e.g., Windows® or Swing®, at either run-time or upon receipt of the tag language defining the panel. The GUI panel builder 327, on the other hand, is a tool that generates an image of the actual implementation of the GUI panel so as to enable a developer to define or manipulate the look and feel of the GUI panel and the components contained therein. In one embodiment, the GUI panel builder 327 is a What You See Is What You Get (WYSIWYG) builder/editor. In another embodiment, the image of the actual implementation of the GUI panel is platform-independent. Alternatively, the simulated implementation of the GUI panel may be generated, such as simulated panel 635 in FIG. 6. The process for generating such a panel will be discussed in details with reference to FIG. 4.

Data 321 represents any data that serves as input to or output from any program in the computer system 300. The operating system 322 may be a multitasking operating system known in the industry as AIX; however, those skilled in the art will appreciate that the spirit and scope of the present invention is not limited to any one operating system. The operating system 322 preferably supports an object oriented programming environment such as that provided, for example, by the Java programming language.

Referring now to FIG. 4, a process 400 for building a GUI panel in accordance with an embodiment of the present invention is illustrated. At step 410, a user input selecting the GUI panel is received by the GUI panel builder 327. In one embodiment, the GUI panel may be selected from a list of panel options provided by the GUI panel builder 327. The GUI panel may have one or more components, such as buttons and text entry fields. Therefore, one or more additional user inputs selecting the one or more components may be received by the GUI panel builder 327. At step 420, another user input selecting the run-time manager for a desired platform (e.g., Windows®) is received by the GUI panel builder 327. In one embodiment, the panel and the components contained therein correspond to a set of tag language, such as XML and Windows resource script, that defines the panel and the components for the desired platform. In this manner, the GUI panel builder 327 translates the panel and the components contained therein into the corresponding set of tag language without the developer directly writing code in the tag language format. At step 430, the GUI panel builder 327 transfers the set of tag language associated with the panel and the components to the run-time manager. Using the set of tag language, the run-time manager generates the actual implementation of the panel and the components in the platform selected. In one embodiment, the panel generated is a back-end panel (unseen by the developer).

Once the panel is generated, a request is made by the GUI panel builder 327 to the run-time manager 326 for a set of information regarding the panel and components that were just generated (at step 440). In one embodiment, the set of information includes the exact size, position and image of the panel and the components. In another embodiment, the request is made through the interface 328. At step 450, the set of information regarding the panel and the components is subsequently received by the GUI panel builder 327. In one embodiment, the set of information is received through the interface 328. The interface 328 therefore provides the means through which the GUI panel builder 327 and the run-time manager 326 communicate.

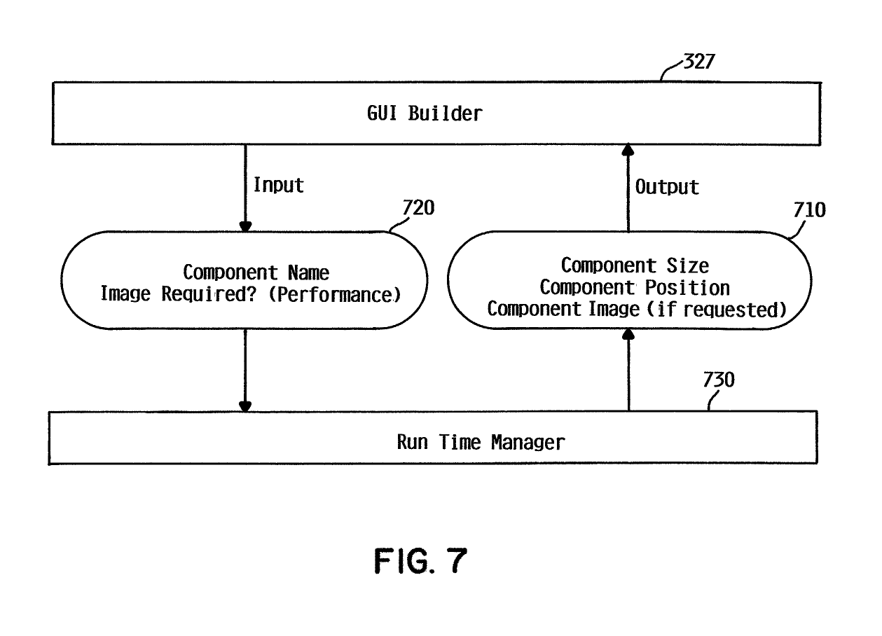

Referring now to FIG. 7, a block diagram of the interaction between the GUI builder 327 and a run time manager 730 is illustrated in accordance with an embodiment of the invention. The run time manager 730 is configured to receive the request for the set of information regarding the panel and the components from the GUI builder 327. In one embodiment, the request may only be a component name (block 720). In response, the run time manager returns the component size, position and image to the GUI builder 327 (block 710). In accordance with an embodiment of the invention, if conservation of system performance is necessary, the image information is not requested.

Referring back to FIG. 4, at step 460, the GUI panel builder 327 uses the set of information regarding the actual implementation of the panel and the components to generate an image of the panel and the components. At step 470, the image of the panel and the components is displayed to the developer for further development. In one embodiment, the image of the panel and the components is a substantial representation of the panel and the components, as generated by the run-time manager 326. In this manner, the image is a WYSIWYG representation of the actually implemented panel and its components. Using the embodiments of the present invention, the developer can see, in real time, exactly how the panel being built will look at run-time.

In accordance with an embodiment of the present invention, if the developer desires to view an image of the panel and the components for a second platform, e.g., HTML (block 625 in FIG. 6), the developer simply inputs a selection for a run-time manager (from the available run-time managers 236) for the second platform, e.g., an HTML run time manager (block 620 in FIG. 6), to the GUI panel builder 327. Once the user input selecting a run-time manager for the second platform is received, processing continues with steps 430 to 470, as previously described, until the image of the panel and the components for second platform is displayed to the developer. If the developer desires to view an image of the panel and components for a third platform, e.g., Java Swing® (block 615 in FIG. 6), the developer simply needs to input a selection for a run time manager for the Java run time manager (block 610 in FIG. 6). This process may be repeated for as many times the developer desires. Thus, embodiments of the present invention enable the developer to simultaneously view a particular GUI panel for different platforms. In one embodiment, the various images are displayed on a split-screen format.

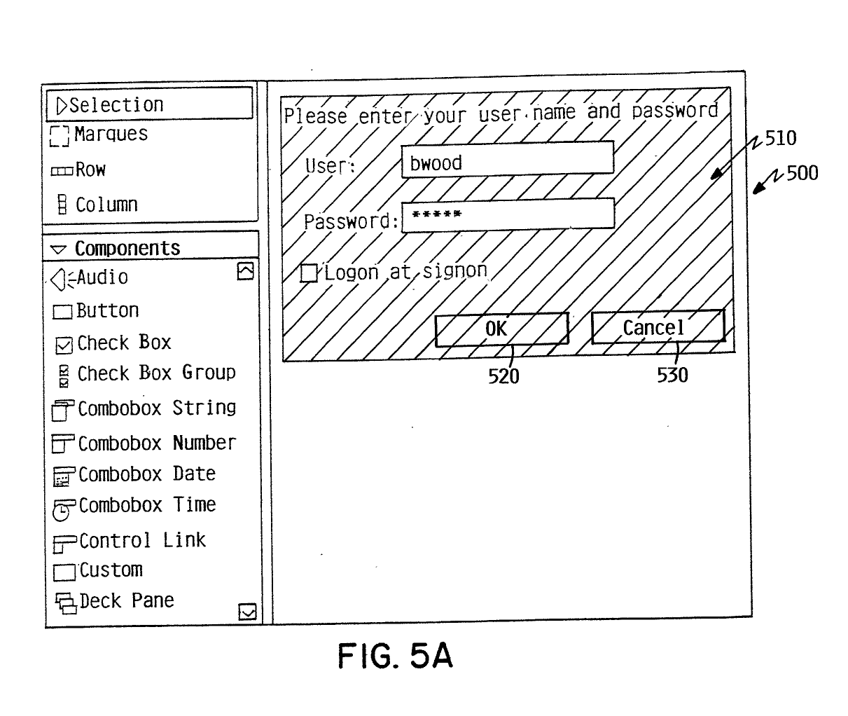

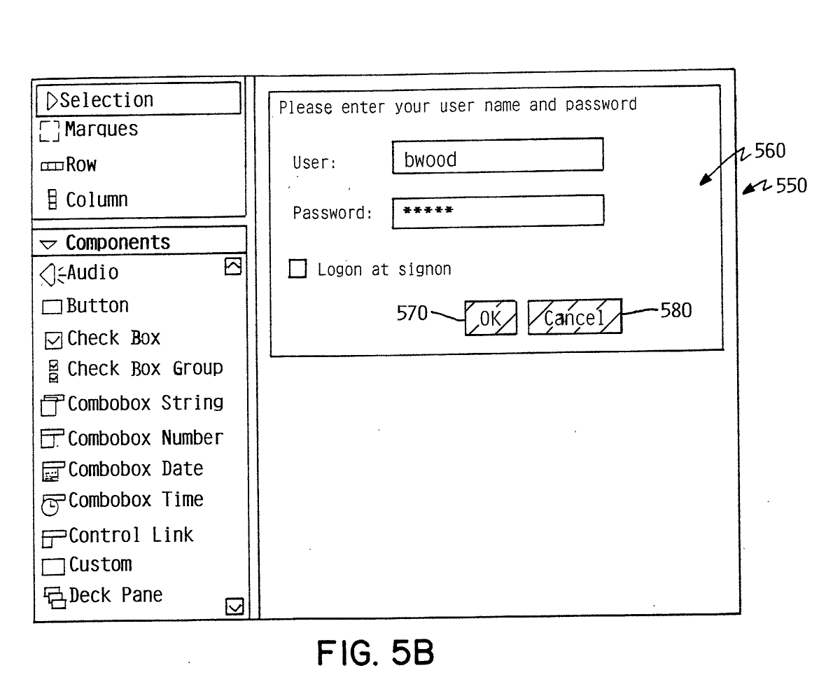

FIG. 5A illustrates an image of a log-on GUI panel for Windows®, while FIG. 5B illustrates an image of a log-on GUI panel for HTML, in accordance with an embodiment of the invention. The look and feel of the image for Windows® are distinguishable from the image for HTML. For instance, the color (represented by cross hatching) in a text area 510 of FIG. 5A is different from the color in a text area 560 of FIG. 5B. The font of the words in FIG. 5A is also different from the font in FIG. 5B. Moreover, the size of the “OK” component 520 and the “Cancel” component 530 in FIG. 5A is significantly larger than size of the “OK” component 570 and the “Cancel” component 580 in FIG. 5B. This variance in the look and feel of each panel in the different platform underscores the importance of enabling the developer to simultaneously see the exact image of the panels, as they are implemented.

In accordance with one embodiment, prior to receiving the user input selecting the run-time manager for a particular platform (at step 420), the prior image of the panel and the components for that particular platform along with the prior set of tag language defining the prior image of the panel and the components for that particular platform are discarded. In this manner, the GUI panel is refreshed. In accordance with another embodiment of the present invention, the entire process 400 is repeated each time the developer desires to build a new GUI panel. In accordance with yet another embodiment, the run-time manager for the particular platform is run to generate the actual implementation of the GUI panel in that particular platform at run-time.

While the foregoing is directed to embodiments of the present invention, other and further embodiments of the invention may be devised without departing from the basic scope thereof, and the scope thereof is determined by the claims that follow.

What is claimed is:

1. A method of building a graphical user interface panel, comprising:
receiving a first set of user inputs selecting a panel and one or more components contained within the panel;
generating, by a graphical user interface panel builder, an image of the panel and the components by using a set of information regarding the panel and the components received from a run-time manager; and
displaying, by a graphical user interface panel builder, the image of the panel and the components.

2. The method of claim 1, wherein generating an image of the panel and the components by using the set of information regarding the panel and the components received from a run-time manager comprises receiving a user input selecting the run-time manager from a group of run-time managers, each of which is configured for generating the panel and the components for different platforms.

3. The method of claim 1, wherein generating an image of the panel and the components by using the set of information regarding the panel and the components received from a run-time manager comprises:
receiving a user input selecting the run-time manager for a desired platform;
transferring to the run-time manager a set of tag language defining the panel and the components for the desired platform;
requesting from the run-time manager the set of information regarding the panel and the components; and
receiving from the run-time manager the set of information regarding the panel and the components.

4. The method of claim 1, wherein generating an image of the panel and the components by using the set of information regarding the panel and the components received from a run-time manager comprises:
receiving a user input selecting the run-time manager for a desired platform;
transferring to the run-time manager a set of tag language defining the panel and the components for the desired platform, the run-time manager being configured for generating the panel and the components for the desired platform upon receiving the set of tag language;
requesting from the run-time manager the set of information regarding the panel and the components; and
receiving from the run-time manager the set of information regarding the panel and the components.

5. The method of claim 1, wherein the set of information regarding the panel and the components comprises at least one of a size, a position and an image of the panel and the components.

6. The method of claim 1, wherein the set of information regarding the panel and components comprises at least one of a size, a position and an image of the panel and the components; and wherein generating an image of the panel and the components by using a set of information regarding the panel and the components received from a run-time manager comprises:
receiving a user input selecting the run-time manager for a desired platform;
transferring to the run-time manager a set of tag language defining the panel and the components for the desired platform, the run-time manager being configured for generating the panel and the components for the desired platform upon receiving the set of tag language;
requesting from the run-time manager the set of information regarding the panel and the components; and
receiving from the run-time manager the set of information regarding the panel and the components.

7. The method of claim 1, wherein the set of information regarding the panel and components comprises at least one of a size, a position and an image of the panel and the components; and wherein generating an image of the panel and the components by using a set of information regarding the panel and the components received from a run-time manager comprises:
receiving a user input selecting the run-time manager for a desired platform;
transferring to the run-time manager a set of tag language defining the panel and the components for the desired platform;
requesting from the run-time manager the set of information regarding the panel and the components; and
receiving from the run-time manager the set of information regarding the panel and the components.

8. A method of building a graphical user interface panel, comprising:
receiving a first set of user inputs selecting a panel and one or more components contained within the panel;
receiving a user input selecting a run time manager from a group of run-time managers, each of which is configured for generating the panel and components for different platforms.

9. A method of refreshing a graphical user interface panel having one or more components contained within the panel, the method comprising:
receiving a user input selecting a run-time manager for a desired platform;
transferring to the run-time manager a set of tag language defining the panel and the components for the desired platform;
requesting from the run-time manager a set of information regarding the panel and the components;
receiving from the run-time manager the set of information regarding the panel and the components;
generating an image of the panel and the components by using a set of information regarding the panel and the components received from a run-time manager; and
displaying the image of the panel and the components.

10. The method of claim 9, further comprising, prior to receiving the user input selecting the run-time manager, discarding one of a prior image of the panel and the components for the desired platform and a prior set of tag language defining the panel and the components for the desired platform.

11. The method of claim 9, wherein the run-time manager is configured for generating the panel and the components in a back-end panel upon receiving the set of tag language.

12. The method of claim 9, wherein the set of information regarding the panel and components comprises at least one of a size, a position and an image of the panel and the components.

13. A computer readable medium containing a program which, when executed, performs an operation comprising:
receiving a first set of user inputs selecting the panel and one or more components contained within the panel;
generating an image of the panel and the components by using a set of information regarding the panel and the components received from a run-time manager; and
displaying the image of the panel and the components.

14. The computer readable medium of claim 13, wherein generating an image of the panel and the components by using a set of information regarding the panel and the components received from a run-time manager comprises receiving a user input selecting the run-time manager from a group of run-time managers, each of which is configured for generating the panel and the components for different platforms.

15. The computer readable medium of claim 13, wherein generating an image of the panel and the components by using a set of information regarding the panel and the components received from a run-time manager comprises:
receiving a user input selecting the run-time manager for a desired platform;
transferring to the run-time manager a set of tag language defining the panel and the components for the desired platform;
requesting from the run-time manager the set of information regarding the panel and the components; and
receiving from the run-time manager the set of information regarding the panel and the components.

16. The computer readable medium of claim 13, wherein the set of information regarding the panel and components comprises at least one of a size, a position and an image of the panel and the components.

17. The computer readable medium of claim 13, wherein the set of information regarding the panel and components comprises at least one of a size, a position and an image of the panel and the components; and wherein generating an image of the panel and the components by using a set of information regarding the panel and the components received from a run-time manager comprises:
receiving a user input selecting the run-time manager for a desired platform;
transferring to the run-time manager a set of tag language defining the panel and the components for the desired platform, the run-time manager being configured for generating the panel and the components for the desired platform upon receiving the set of tag language;
requesting from the run-time manager the set of information regarding the panel and the components; and
receiving from the run-time manager the set of information regarding the panel and the components.

18. A computer readable medium containing a program which, when executed, performs an operation comprising:
receiving a user input selecting a run-time manager for a desired platform;
transferring to the run-time manager a set of tag language defining the panel and the components for the desired platform;
requesting from the run-time manager a set of information regarding the panel and the components;
receiving from the run-time manager the set of information regarding the panel and the components;
using the set of information regarding the panel and the components to generate an image of the panel and the components; and
displaying the image of the panel and the components.

19. The computer readable medium of claim 18, further comprising, prior to receiving the user input selecting the run-time manager, discarding one of a prior image of the panel and the components for the desired platform and a prior set of tag language defining the panel and the components for the desired platform.

20. The computer readable medium of claim 18, wherein the run-time manager is configured for generating the panel and the components in a back-end panel upon receiving the set of tag language.

21. The computer readable medium of claim 18, wherein the set of information regarding the panel and components comprises at least one of a size, a position and an image of the panel and the components.

22. A computer, comprising:
a memory containing a graphical user interface-building program; and
a processor which, when executing the graphical user interface-building program, performs an operation comprising:
receiving a first set of user inputs selecting the panel and one or more components contained within the panel;
generating an image of the panel and the components by using a set of information regarding the panel and the components received from a run-time manager; and
displaying the image of the panel and the components.

23. The computer of claim 22, wherein generating an image of the panel and the components by using a set of information regarding the panel and the components received from a run-time manager comprises receiving a user input selecting the run-time manager from a group of run-time managers, each of which is configured for generating the panel and the components for different platforms.

24. The computer of claim 22, wherein generating an image of the panel and the components by using a set of information regarding the panel and the components received from a run-time manager comprises:
receiving a user input selecting the run-time manager f or a desired platform;
transferring to the run-time manager a set of tag language defining the panel and the components for the desired platform;
requesting from the run-time manager the set of information regarding the panel and the components; and
receiving from the run-time manager the set of information regarding the panel and the components.

25. The computer of claim 22, wherein the set of information regarding the panel and the components comprises at least one of a size, a position and an image of the panel and the components.

26. The computer of claim 22, wherein the set of information regarding the panel and components comprises at least one of a size, a position and an image of the panel and the components; and wherein using the set of information regarding the panel and the components received from the run-time manager to construct the image of the panel and the components comprises:
receiving a user input selecting the run-time manager for a desired platform;
transferring to the run-time manager a set of tag language associated with the panel and the components for the desired platform, the set of tag language defining the panel and the components for the desired platform, the run-time manager being configured for generating the panel and the components for the desired platform upon receiving the set of tag language;
requesting from the run-time manager the set of information regarding the panel and the components; and
receiving from the run-time manager the set of information regarding the panel and the components.

27. A computer, comprising:
a memory containing a graphical user interface panel-refreshing program, the panel having one or more components contained within the panel; and
a processor which, when executing the graphical user interface panel-refreshing program, performs an operation comprising:
receiving a user input selecting a run-time manager for a desired platform;
transferring to the run-time manager a set of tag language defining the panel and the components for the desired platform;
requesting from the run-time manager a set of information regarding the panel and the components;
receiving from the run-time manager the set of information regarding the panel and the components;
using the set of information regarding the panel and the components to generate an image of the panel and the components; and
displaying the image of the panel and the components.

28. The computer of claim 27, wherein the operation further comprises, prior to receiving the user input selecting the run-time manager, discarding one of a prior image of the panel and the components for the desired platform and a prior set of tag language defining the panel and the components for the desired platform.

29. The computer of claim 27, wherein the run-time manager is configured for generating the panel and the components in a back-end panel upon receiving the set of tag language.

30. The computer of claim 27, wherein the set of information regarding the panel and the components comprises at least one of a size, a position and an image of the panel and the components.
